(19) United States
(12) Patent Application Publication
(10) Pub. No.: US 2018/0173046 A1
(43) Pub. Date: Jun. 21, 2018

(54) METHOD FOR MANUFACTURING COLOR FILTER SUBSTRATE, COLOR FILTER SUBSTRATE, AND LIQUID CRYSTAL DISPLAY

(71) Applicant: Wuhan China Star Optoelectronics Technology Co., Ltd., Wuhan, Hubei (CN)

(72) Inventors: Hong YANG, Shenzhen, Guangdong (CN); Yanchang SHI, Shenzhen, Guangdong (CN)

(73) Assignee: Wuhan China Star Optoelectronics Technology Co., Ltd., Wuhan, Hubei (CN)

(21) Appl. No.: 15/313,090

(22) PCT Filed: Jun. 12, 2016
(86) PCT No.: PCT/CN2016/085466

§ 371 Date: Nov. 21, 2016

(30) Foreign Application Priority Data
Mar. 15, 2016 (CN) 201610148191.5

(51) Int. Cl. G02F 1/1335; G02F 1/1337; G02F 1/1339

(52) U.S. Cl. CPC G02F 1/133516; G02F 1/13394; G02F 1/1337; G02F 1/133512

(57) ABSTRACT

The present invention provides one of manufacturing color filter substrate, color filter substrate and liquid crystal display, which comprises providing a substrate; arranging a black matrix on the substrate, the black matrix defines a plurality of color resist areas spaced from each other; arranging a color resist image on the color resist area; arranging an alignment layer on the black matrix and the color resist image, to take advantage of the alignment layer so as to fill recessed areas arranged between color resist image. By arranging an alignment layer directly on color resist image and the black matrix, so as to take advantage of the alignment layer to fill recessed areas arranged between color resist image. Without arranging an over coat and thereby reducing a process, so as to increase production capacity.

### FIELD OF THE INVENTION

The present invention relates to a technology of liquid crystal display, and more particularly, to a method of manufacturing color filter substrate, color filter substrate and liquid crystal display.

### DESCRIPTION OF PRIOR ART

With the increasing popularity of mobile display, the technology of mobile display to a new generation of development, which includes high-quality, high-resolution, lightweight and low-power. LTPS (Low Temperature Poly-silicon) technology attracts consumers by its superior high-quality, high-resolution, ultra-thin and low power performance. LTPS technology is gradually replacing the traditional a-Si TFT technology and become a new generation display technology mainstream.

The production process of traditional LTPS CF (color filter substrate) needs to produce dispose an OC (over coat) layer over a glass substrate, covering the BM (black matrix) and RGB (color resist image) in a middle area so as to make CF flat (or leveled) and reduce obstacles of liquid crystal twisting. Because of OC layer is useless except smoothing the surface of the CF, so as to increase whole production cycle of CF and result in production capacity loss.

### SUMMARY OF THE INVENTION

It is an object of this present invention to provide a method of manufacturing color filter substrate, color filter substrate, liquid crystal display panel, flip chip and its packaging method, so as to simplify the production process and increase production capacity.

In order to resolve the problem encountered by the prior art, the present invention provides a method of manufacturing color filter substrate, including:

providing a substrate; arranging a BM (black matrix) on the substrate, the BM defines a plurality of color resist areas spaced from each other; arranging a RGB (color resist image) on the color resist area; arranging an alignment layer on the BM and the RGB, to take advantage of the alignment layer to fill recessed areas arranged between RGB.

Wherein, arranging the RGB to extend over the BM, and the RGB and the BM pattern are partially overlapped with each other.

Wherein, before the step of arranging the RGB and the BM on the alignment layer, further including: a support column arranged between the BM and the RGB;

in the step of arranging an alignment layer on the RGB and the BM, further including:

using the alignment layer to cover the support column.

Wherein, the step of arranging an alignment layer on the RGB and the BM includes:

arranging the alignment layer which is be contacted with the RGB and the BM directly.

In order to resolve the problem encountered by the prior art, the present invention provides a CF (color filter substrate), including: a substrate, a BM is located on the substrate, a BM on the substrate which defines a RGB with plurality of color resist areas spaced from each other;

And an alignment layer which in the above the RGB and the BM is located on the substrate, which filling recessed areas arranged between RGB.

Wherein, the RGB extends over the BM, and the RGB and the BM pattern are partially overlapped.

Wherein, further includes a support column arranged between the BM and the RGB so as to support the substrate, the alignment layer covers the support column.

Wherein, the RGB comprises spaced red, green, and blue color resist.

Wherein, the material of the BM is black conductive photosensitive polymer resin mixture.

In order to resolve the problem encountered by the prior art, the present invention provides a liquid crystal display panel, including: an array substrate, a color filter substrate and a liquid crystal layer which is arranged between the array substrate and the color filter substrate.

The color filter substrate includes: a BM is located on the substrate, a BM on the substrate which defines a plurality of color resist areas spaced from each other and an alignment layer which in the above the RGB and the BM is located on the substrate, filling recessed areas arranged between RGB.

Wherein, the RGB extends over the BM, and the RGB and the BM pattern are partially overlapped with each other.

Wherein, further includes a support column arranged between the BM and the RGB so as to support the substrate, the alignment layer covers the support column.

Wherein, RGB comprises red, green, and blue color resists arranged separately with each other.

Wherein, the material of the BM is a black conductive photosensitive polymer resin mixture.

The present invention can be concluded with the following advantages: The present invention is different from the prior art of manufacturing a CF and a CF, a liquid crystal display panel. By arranging an alignment layer directly on RGB and the BM, so as to take advantage of the alignment layer to fill recessed areas arranged between RGB. Without arranging an OC and thereby reducing a process, so as to increase production capacity.

### BRIEF DESCRIPTION OF DRAWINGS

FIG. 1 is a flow chart of method one of manufacturing color filter substrate in the present invention;

FIG. 2 is a structural illustration of an embodiment made in accordance to a color filter substrate in the present invention; and

FIG. 3 is a structural illustration of an embodiment made in accordance to a liquid crystal display panel in the present invention.

### DESCRIPTION OF PREFERRED EMBODIMENT

Detailed description will be given by following description in order to fully understand the present invention. However, the present invention can be implemented in different from many other ways which described herein. Technical staff in this field can extend similarly without departing from the intention of the present invention. Therefore, the present invention is not limited to the particular embodiment disclosed below.

In order to overcome the defects encountered by those prior arts, the present invention provides a method of manufacturing color filter substrate. Detailed description will be given in view of Figures and preferred embodiments.

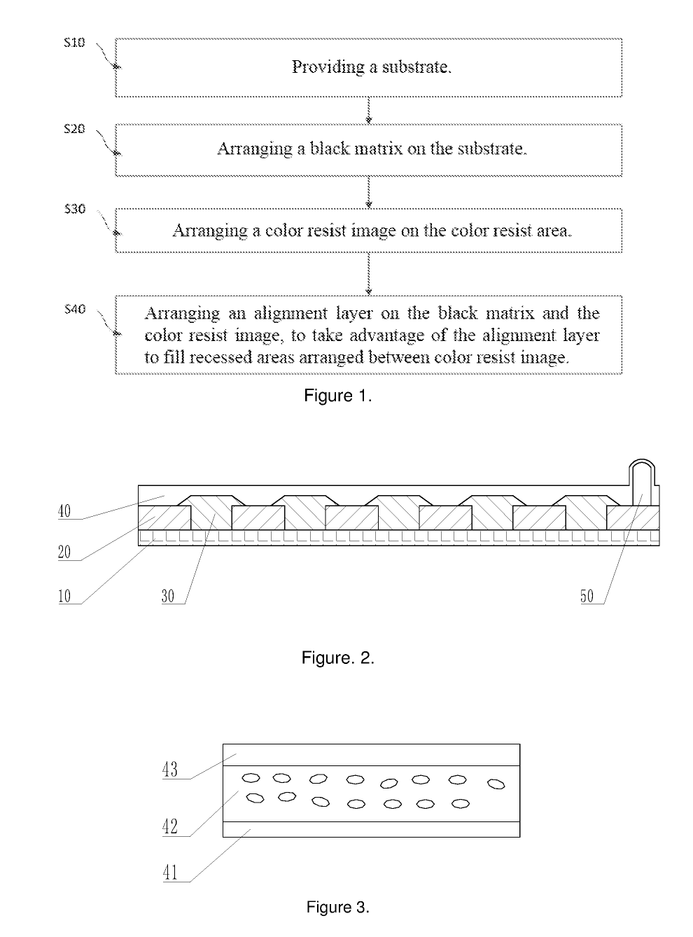

Referring to FIG. 1, FIG. 1 is a flow chart of method one of manufacturing CF (color filter substrate) in the present invention. The method specifically includes the steps of:

S10 describes providing a substrate; the substrate may be glass, plastic and other materials, it is not specifically defined herein;

S20 describes arranging a BM (black matrix) on the substrate, the BM defines a plurality of color resist areas spaced from each other;

S30 describes arranging a RGB (color resist image) on the color resist area;

The BM is an opaque area which is deposited between in RGB. It can prevent the background light leakage, improve the display contrast and prevent the color mixing and increase the color purity. Since the BM requires an optical density of 3 or more, therefore choosing a method of photolithography to produce an image by sputtering a chromium layer on a glass substrate. It may use a photoresist resin which containing a black dye.

S40 describes arranging an alignment layer on the BM and the RGB, to take advantage of the alignment layer to fill recessed areas arranged between RGB.

Preferably, S30 describes arranging a RGB on the RGB, including the step of arranging the RGB over the BM, and the RGB and the BM pattern are partially overlapped, in order to avoid background light leakage.

Preferably, S40 describes that before the step of arranging the RGB and the BM on the alignment layer, further including a support column arranged between the BM and the RGB, and using the alignment layer to cover the support column.

Preferably, S40 describes that in the step of arranging an alignment layer on the RGB and the BM include: arranging the alignment layer which is be contacted with the RGB and the BM directly.

In the method one of manufacturing CF in the present invention, by arranging an alignment layer directly on RGB and the BM, so as to take advantage of the alignment layer to fill recessed areas arranged between RGB. Without producing an OC (over coat) and thereby reducing a working process, so as to increase production yield.

Referring to FIG. 2, FIG. 2 is a structural illustration of an embodiment made in accordance to a CF in the present invention, including:

a substrate 10, the substrate may be a material, such as glass or plastic;

a BM 20 is located on the substrate 10. The BM 20 is the opaque area which is deposited between in RGB. It can prevent background light leakage, improve the display contrast and prevent color mixing and increase the color purity. Since the BM requires an optical density of 3 or more, therefore choosing a method of photolithography to produce an image by sputtering a chromium layer on a glass substrate. It may use a photoresist resin which containing a black dye.

Wherein, preferably, the material of the BM 20 is a black conductive photosensitive polymer resin mixture.

The BM 20 on the substrate 10 which defines a RGB 30 with a plurality of color resist areas spaced from each other; wherein, the RGB 30 extends over the BM 20, and the RGB and the BM pattern are partially overlapped with each other, in order to avoid background light leakage.

Wherein, preferably, the RGB 30 includes spaced red, green, and blue color resist.

And the alignment layer 40 which in the above the RGB 30 and the BM 20 is located on the substrate, filling recessed areas arranged between RGB, wherein the alignment layer 40 is be contacted with the RGB 30 and the BM 20 directly, rather than arranging an OC.

Referring to FIG. 2, In the preferably embodiment made in accordance to a color filter substrate of the present invention, a support column 50 arranged between the BM 20 and the RGB 30 so as to support the substrate 10, the alignment layer 40 covers the support column.

In the embodiment made in accordance to a color filter substrate of the present invention, by arranging an alignment layer 40 directly on RGB 30 and the BM 20, so as to take advantage of the alignment layer 40 to fill recessed areas arranged between RGB 30. Without arranging an OC and thereby simplifying the structure of the CF, so as to reduce a process and increase production capacity.

Referring to FIG. 3, the present invention is also to provide a liquid crystal display panel, including: an array substrate 41, a CF 42 and a liquid crystal layer 43 which is disposed between the array substrate and the CF.

Wherein, the specific structure and method of manufacturing of CF 42 are similar to above-described embodiment. The specific related description is refer to the embodiment of a CF and preferable embodiment.

In the embodiment of a liquid crystal display panel in the present invention. By arranging an alignment layer directly on the RGB and the BM, the CF 42 take advantage of the alignment layer to fill recessed areas arranged between RGB. Without arranging an OC and thereby reducing a process, so as to increase production capacity.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

1. A method of manufacturing color filter substrate, including the steps of:
providing a substrate;
arranging a black matrix on the substrate, the black matrix defines a plurality of color resist areas spaced from each other;
arranging a color resist image on the color resist area;
arranging an alignment layer on the black matrix and the color resist image, to take advantage of the alignment layer so as to fill recessed areas arranged between color resist image.

2. The method of manufacturing color filter substrate as recited in claim 1, wherein the step of arranging a color resist image on the color resist image includes:
arranging the color resist image over the black matrix, and
the color resist image and the black matrix pattern are partially overlapped with each other.

3. The method of manufacturing color filter substrate as recited in claim 1, wherein before the step of arranging the color resist image and the black matrix on the alignment layer further includes:
a support column arranged between the black matrix and the color resist image; and
in the step of arranging an alignment layer on the color resist image and the black matrix, which further includes:
using the alignment layer to cover the support column.

4. The method of manufacturing color filter substrate as recited in claim 1, wherein in the step of arranging an alignment layer on the color resist image and the black matrix includes:
arranging the alignment layer which is be contacted with the color resist image and the black matrix directly.

5. A color filter substrate, wherein a color filter substrate includes:
a substrate;
a black matrix is located on the substrate;
a black matrix on the substrate which defines a color resist image with plurality of color resist areas spaced from each other; and
an alignment layer which in the above the color resist image and the black matrix is located on the substrate, filling recessed areas arranged between color resist image.

6. The color filter substrate as recited in claim 5, wherein the color resist image extends over the black matrix, and the color resist image and the black matrix pattern are partially overlapped with each other.

7. The color filter substrate as recited in claim 5, wherein the color filter substrate further includes a support column arranged between the black matrix and the color resist image so as to support the substrate, wherein the alignment layer covers the support column.

8. The color filter substrate as recited in claim 5, wherein the color resist image comprises red, green, and blue color resists arranged separately with each other.

9. The color filter substrate as recited in claim 5, wherein the material of the black matrix is a black conductive photosensitive polymer resin mixture.

10. A liquid crystal display panel, wherein a liquid crystal display panel includes an array substrate, a color filter substrate and a liquid crystal layer which is disposed between the array substrate and the color filter substrate, the color filter substrate includes:
a substrate;
a black matrix is located on the substrate;
a color resist image of the black matrix defines a plurality of color resist areas spaced from each other, which is located on the substrate; and
an alignment layer which in the above the color resist image and the black matrix is located on the substrate so as to fill the trench between the color resist image and the black matrix.

11. The liquid crystal display panel as recited in claim 10, wherein the color resist image extends over the black matrix, and the color resist image partially overlaps the black matrix.

12. The color filter substrate as recited in claim 10, wherein, further includes a support column arranged in space between the black matrix and the color resist image; support column is used to support the substrate, wherein the alignment layer covers the support column.

13. The color filter substrate as recited in claim 10, wherein, the color resist image comprises red, green, and blue color resists arranged separately with each other.

14. The color filter substrate as recited in claim 10, wherein the material of the black matrix is black conductive photosensitive polymer resin mixture.
